(19) United States
(12) Patent Application Publication
(10) Pub. No.: US 2026/0335870 A1
(43) Pub. Date: Oct. 29, 2026

(54) CATALYSTS, METHODS FOR MAKING SUCH CATALYSTS, AND USES FOR SUCH CATALYSTS IN AMMONIA CRACKING TO PRODUCE HYDROGEN

(71) Applicant: Saudi Arabian Oil Company, Dhahran (SA)

(72) Inventors: Emad N. Al-Shafei, Saihat (SA); Reem N. Albashrawi, Qatif (SA); Mohammad F. Aljishi, Dhahran (SA)

(73) Assignee: Saudi Arabian Oil Company, Dhahran (SA)

(21) Appl. No.: 19/191,345

(22) Filed: Apr. 28, 2025

(51) Int. Cl. B01J 23/78; B01J 21/04; B01J 23/04; B01J 35/00; B01J 35/30; B01J 35/61; B01J 35/63; B01J 35/64; B01J 37/02; B01J 37/08; C01B 3/047

(52) U.S. Cl. CPC B01J 23/78; B01J 21/04; B01J 23/04; B01J 35/19; B01J 35/397; B01J 35/613; B01J 35/633; B01J 35/647; B01J 37/0244; B01J 37/08; C01B 3/047

(57) ABSTRACT

Disclosed herein is a catalyst that may comprise a core portion, an intermediate shell layer, and an outer shell layer. The core portion may comprise alpha-alumina. The intermediate shell layer may surround the core portion. The intermediate shell layer may comprise an alkali metal oxide. The outer shell layer may surround the intermediate shell layer. The outer shell portion may comprise an alkali metal oxide and nickel oxide. The alkali metal oxide of the outer shell layer and the nickel oxide may be mixed in the outer shell layer. Also disclosed herein are methods of catalytically cracking ammonia with such catalysts, and methods for making such catalysts.

### TECHNICAL FIELD

Embodiments of the present disclosure generally relate to chemical processing and, more specifically, to catalysts useful in chemical processing.

### BACKGROUND

Catalysts are useful for a very wide variety of chemical processing technologies. One such chemical processing technology that may utilized catalysts is ammonia cracking to produce hydrogen (H₂). Hydrogen formation by ammonia cracking can be a valuable industrial process, given the high value of hydrogen. For example, hydrogen can be useful as a portably fuel source, as well as for use as an input in a wide variety of industrial processes.

### BRIEF SUMMARY

Ammonia cracking is a valuable industrial process, but some conventional embodiments of ammonia cracking are inefficient. New catalysts are needed to improve ammonia cracking, among other possible catalytic functionality. Embodiments of the present disclosure provide, according to one or more embodiments, catalysts, methods for making such catalysts, and methods for using such catalysts for cracking of ammonia. It has been presently discovered that catalysts that include a core portion that comprises alpha-alumina, an intermediate shell layer that comprises alkali metal oxide, and an outer shell layer that comprise a mixture of alkali metal oxide and nickel oxide has relatively good catalytic performance for ammonia cracking. Such ammonia cracking may be carried out, according to some embodiments, at relatively low process temperatures with relatively good conversion.

According to one or more embodiments, a catalyst may comprise a core portion, an intermediate shell layer, and an outer shell layer. The core portion may comprise alpha-alumina. The intermediate shell layer may surround the core portion. The intermediate shell layer may comprise an alkali metal oxide. The outer shell layer may surround the intermediate shell layer. The outer shell portion may comprise an alkali metal oxide and nickel oxide. The alkali metal oxide of the outer shell layer and the nickel oxide may be mixed in the outer shell layer.

According to one or more additional embodiments, ammonia may be catalytically cracked by a method that may comprise contacting ammonia with the catalyst of claim 1 to form H₂. The catalyst may comprise a core portion, an intermediate shell layer, and an outer shell layer. The core portion may comprise alpha-alumina. The intermediate shell layer may surround the core portion. The intermediate shell layer may comprise an alkali metal oxide. The outer shell layer may surround the intermediate shell layer. The outer shell portion may comprise an alkali metal oxide and nickel oxide. The alkali metal oxide of the outer shell layer and the nickel oxide may be mixed in the outer shell layer.

According to one or more yet additional embodiments, a method for making a catalyst may comprise depositing a precursor intermediate shell layer onto a core portion such that the precursor intermediate shell layer surrounds the core portion. The core portion may comprise alpha-alumina. The precursor intermediate shell layer may comprise an alkali metal-containing compound. The method may further comprise calcining the precursor intermediate shell layer to form an intermediate shell layer comprising alkali metal oxide, and depositing a precursor outer shell layer onto the intermediate shell layer such that the precursor outer shell layer surrounds the intermediate shell layer. The precursor outer shell layer may comprise a mixture comprising an alkali metal-containing compound and a nickel-containing compound. The method may further comprise calcining the precursor outer shell layer to form an outer shell layer that may comprise alkali metal oxide and nickel oxide.

These and other embodiments are described in more detail in the Detailed Description. It is to be understood that both the foregoing general description and the following detailed description present embodiments of the presently disclosed technology, and are intended to provide an overview or framework for understanding the nature and character of the technology as it is claimed. The accompanying drawings are included to provide a further understanding of the presently disclosed technology and are incorporated into and constitute a part of this specification. The drawings illustrate various embodiments and, together with the description, serve to explain the principles and operations of the presently disclosed technology. Additionally, the drawings and descriptions are meant to be merely illustrative, and are not intended to limit the scope of the claims in any manner.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a cross-sectional view of a catalyst, according to one or more embodiments described in this disclosure.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

One or more embodiments of the present disclosure relate to catalysts that are useful in ammonia cracking. Additional embodiments relate to methods to make such catalysts. Further methods relate to methods for utilizing such catalysts in ammonia cracking. While it should be appreciated that the catalysts descried herein are suitable for use in ammonia cracking, they may offer other catalytic functionality and should not be limited in scope to application for ammonia cracking. However, in general, the catalysts described herein are described in the context of their use in ammonia cracking.

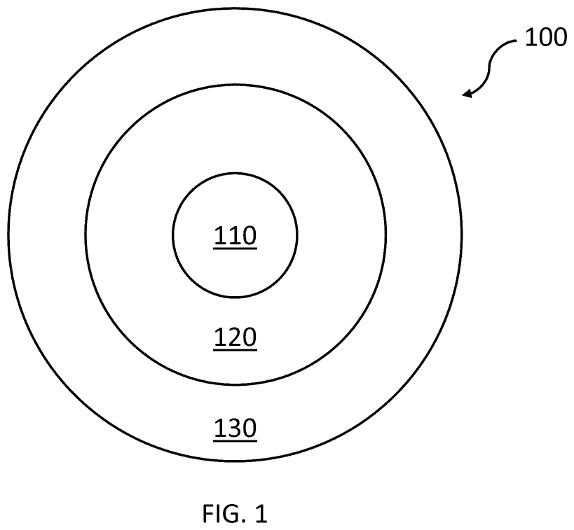

Now referring to FIG. 1, according to one or more embodiments, a catalyst 100 may comprise a core portion 110, an intermediate shell layer 120, and an outer shell layer 130. As depicted, the intermediate shell layer 120 may surround the core portion 110, and the outer shell layer 120 may surround the intermediate shell layer 120. The catalyst 100 may have a generally spherical shape in some embodiments, but in other embodiments may have other shapes largely based on the shape of the core portion 110 upon with the intermediate shell layer 120 and the outer shell layer 120 are deposited upon. Each of the core portion 110, the intermediate shell layer 120, and the outer shell layer 120 may be substantially homogenous, respectively, such that the components of each of these portions is substantially intermixed. In some embodiments, the core portion 110 directly contacts the intermediate shell layer 120, and the intermediate shell layer 120 directly contacts the outer shell layer 120. However, in additional embodiments, it is contemplated that other intermediate layers (not depicted in FIG. 1) may be present in the catalyst 100. As depicted, in some embodiments, the outer shell layer 130 may be the outermost layer of the catalyst 100 and define the edges of the catalyst 100 that contact the surrounding environment.

According to one or more embodiments, the catalyst 100 may have a diameter (or longest length if non-spherical) of from 2 mm to 50 mm, such as from 2 mm to 10 mm. For example, the catalyst 100 may have a diameter of from 2 mm to 10 mm, from 10 mm to 20 mm, from 20 mm to 30 mm, from 30 mm to 40 mm, from 40 mm to 50 mm, or any combination of these ranges.

In one or more embodiments, the core portion 110 comprises alpha-alumina. As is understood by those skilled in the art, alpha-alumina (a-alumina) refers to alumina that generally has a hexagonal crystal structure. The determination of whether alumina is in the alpha-alumina form can generally be made by those skilled in the art utilizing X-ray diffraction or other known techniques. In some embodiments, the core portion 110 may consist of or consist essentially of alpha-alumina. In some embodiments, the core portion 110 may comprise alpha-alumina in an amount of greater than or equal to 75 wt. %, greater than or equal to 90 wt. %, or greater than or equal to 95 wt. %.

Without being bound by any particular theory, it is believed that the catalyst 100 may have enhanced catalytic performance for ammonia cracking as compared to conventional catalyst that do not include an alpha-alumina core portion 110. The alpha-alumina core portion 110 may act as a catalyst support. Alpha-alumina is one of the most stable forms of alumina. In the context of catalysis and material science, supports are materials used to disperse or anchor active catalyst particles, enhancing their stability and effectiveness. Alpha-alumina is characterized by its high thermal stability, mechanical strength, and resistance to chemical attack, making it an excellent support material for various catalytic reactions, especially those utilizing high temperatures. In catalytic applications, the support material is not necessarily the active phase but it plays a crucial role in dispersing of the active material and preventing agglomeration and allowing for more effective catalytic sites. In addition, the support of alpha-alumina can withstand high temperatures without breaking down, essential for high-temperature catalytic processes. Although the alpha-alumina does not have as high a surface area as other alumina phases (like gamma-alumina), it provides sufficient area for catalyst dispersion and interaction with reactants. When compared with gamma-alumina, alpha-alumina is characterized by lower surface acidity, which is associated with higher catalytic activity for ammonia decomposition. Overall, it is believed that alpha-alumina in the support is important for catalytic processes, providing a mechanically resistant and stable material environment for catalysts to function efficiently and durably.

Still without being bound by any particular theory, it is believed that the choice of alpha-alumina may be superior to, for example, gamma-alumina, due to the attraction of ammonia molecule over the active catalyst and support. It may provide good adsorption of ammonia and desorption of H₂ and N₂ from catalyst at relatively low temperatures than using gamma-alumina as support. This is despite the gamma-alumina, in some embodiments, having better physio and chemo properties such as surface area, highly porosity, and stronger acidity support than alpha-alumina.

According to one or more embodiments, the intermediate shell layer 120 may comprise one or more alkali metal oxides. Contemplated alkali metal oxides include potassium oxide, lithium oxide, sodium oxide, rubidium oxide, and caesium oxide. In some embodiments, the intermediate shell layer 120 may consist of or consist essentially of one or any combination of alkali metal oxides. In some embodiments, the intermediate shell layer 120 may comprise one or any combination of alkali metal oxides in an amount of greater than or equal to 75 wt. %, greater than or equal to 90 wt. %, or greater than or equal to 95 wt. %.

According to one or more embodiments, the outer shell layer 120 may comprise one or any combination of alkali metal oxides and nickel oxide in a mixture. In some embodiments, the outer shell layer 120 may consist of or consist essentially of one or any combination of alkali metal oxides and nickel oxide. In some embodiments, the outer shell layer 120 may comprise one or any combination of alkali metal oxides and nickel oxide, in combination, in an amount of greater than or equal to 75 wt. %, greater than or equal to 90 wt. %, or greater than or equal to 95 wt. %. It should be understood that the one or any combination of alkali metal oxides in the intermediate shell layer 120 may be the same or different from the one or any combination of alkali metal oxides in the outer shell layer 130.

According to one or more embodiments, the weight ratio of one or any combination of alkali metal oxides to nickel oxide in the outer shell layer 130 may be from 1:1 to 1:25, such as from 1:1 to 1:2.5, from 1:2.5 to 1:5, from 1:5 to 1:7.5, from 1:7.5 to 1:10, from 1:10 to 1:15, from 1:15 to 1:20, from 1:20 to 1:25, or any combination of these ranges. Without being bound by any theory, it is believed that these ratios are suitable to promote a desired balance between surface acidity and basicity between the alkali metal oxides and the nickel oxide. In some embodiments, a ratio of from 1:5 to 1:15 may be particularly desirable.

Without being bound by any particular theory, it is believed that addition of alkali metal oxide with nickel oxide over the alpha-alumina core portion 110 may allow for enhanced ammonia molecule activity (i.e., adsorption of ammonia and desorption of H₂ and N₂ from catalyst surface) as compared with using gamma-alumina in core portion 110.

Additionally, without being bound by any theory, it is believed that the presence of the intermediate shell layer 120 and the outer shell layer 130 work together synergistically, with the intermediate shell layer 120 providing electronic or structural support to the outer shell layer 130. In addition, the two-layer structure can act as a buffer zone between the core portion 110 and the outer shell layer 130, aimed to improved durability and lead to longer catalyst lifespan, especially under thermal cycling.

Now described, still with respect to FIG. 1, is a method for making the catalysts described herein. It is contemplated that there may be other methods by which the catalysts described herein may be fabricated, and the methods descried herein should not be considered limiting on the catalysts described herein.

According to one or more embodiments, the catalyst 100 may be formed by a method that comprises at least four steps, as described herein. A first step may include depositing a precursor intermediate shell layer onto the core portion 110 such that the precursor intermediate shell layer surrounds the core portion 110. A second step may include calcining the precursor intermediate shell layer to form the intermediate shell layer 120. A third step may include depositing a precursor outer shell layer onto the intermediate shell layer 120 such that the precursor outer shell layer surrounds the intermediate shell layer 120. A fourth step may include calcining the precursor outer shell layer to form the outer shell layer 130. In some embodiments, the method to form the catalyst 100 may further comprise forming the core portion 110, in a preliminary step. However, in some embodiments, the core portion 110 may be supplied to or be otherwise acquired by a user. In some embodiments, additional steps may be included between the first through fourth steps, as described herein.

It should be understood that “precursor” layers, such as the described precursor intermediate shell layer and the precursor outer shell layer, are transformed into the intermediate shell layer and outer shell layer, respectively. For example, and as is explained herein, such precursor layers may include a metal-containing compound that supplies the metal that is the metal oxide of the described layer, and be formed from the precursor material to the final material of the catalyst 100 by heating and/or calcining steps.

According to some embodiments, the core portion 110 may be formed by a method that comprises calcining aluminum oxide (not in alpha-alumina form) or one or more aluminum-containing compounds, or combinations thereof. As described herein, “calcining” refers to heating a substance to a relatively high temperature (e.g., greater than 600 °C, or even greater than 700 °C) but below the melting point of the substance, causing loss of moisture and, generally, oxidation or other material phase shifting.

Such aluminum-containing compounds may include, without limitation, aluminum hydroxide, aluminum nitrate, aluminum acetate, aluminum chloride, aluminum diacetate, aluminum carbonate, aluminum citrate, aluminum hydroxide oxide, and aluminum isopropoxide. Such formation step may utilize a power mixing technique, where the mixture is transferred to a calcination furnace, where it undergoes a three-stage heating process in atmospheric air or a nitrogen-enriched environment with nitrogen between 10% to 90%. The first stage may heat the sample from room temperature to 350 °C at a rate from 1 to 20 °C/min, maintaining an isotherm from 4 to 8 hours. The second stage may increase the temperature from 350 °C to 700 °C at the same rate, followed by another from 4 to 8 hours isotherm. The third stage may raise the temperature from 700 °C to reach at from 1000 °C to 1300 °C, again at a rate from 1 to 20 °C/min, with a concluding isotherm lasting from 4 to 8 hours. Without being bound by theory, this approach aims to smooth the calcination on the properties and structure of the aluminum compounds to produce the alpha-alumina core portion 110.

In one or more embodiments, once the core portion 110 is provided or fabricated, the first step may take place, comprising depositing a precursor intermediate shell layer onto the core portion 110 such that the precursor intermediate shell layer surrounds the core portion 110. The precursor intermediate shell layer may comprise, consist essentially of, or consist of one or more alkali metal-containing compounds and solvent. The precursor intermediate shell layer may comprise the alkali metal-containing compound in a solvent. A wide variety of alkali metal-containing compounds may be utilized. For example, and Without limitation, potassium-containing compounds may be chosen from potassium hydroxide, potassium carbonate, potassium nitrate, potassium bicarbonate, potassium acetate, potassium tert-butoxide, or potassium citrate. The solvent may be water or a hydrocarbon solvent, and is not necessarily limited. The alkali metal-containing compound may be a mixture with the solvent where the ratio of alkali metal-containing compound to solvent is from 0.1 wt. % to 5 wt. % of alkali metal-containing compound relative to the total weight of the mixture. According to embodiments the mixture of alkali metal-containing compound and solvent may be agitated via stirring or shearing at speeds ranging from 100 to 1500 rpm and a temperature from 20 °C to 80 °C for from 1 to 12 hours. As described herein, the “depositing” of the precursor intermediate shell layer may be by a variety of techniques, and is not particularly limited. However, in some embodiments, the deposition may be by dipping, spraying, or other like techniques. Following the deposition, the core portion 110 with the deposited precursor intermediate shell layer may be rested at ambient temperature and/or dried at from 80 °C to 120 °C from 18 to 48 hours under atmospheric pressure to remove solvent, preparing it for the subsequent second step.

In one or more embodiments, once the first step has taken place, the second step may take place, comprising calcining the precursor intermediate shell layer to form an intermediate shell layer 120 comprising alkali metal oxide. This calcining procedure may drive off any residual solvent and may convert the alkali metal-containing compound into alkali metal oxide. The calcining process may comprise heating the catalyst from room temperature to 700 °C or greater at a rate of 1 to 20 °C/min, followed by an isothermal hold for 4 to 8 hours. Without being bound by theory, this calcination process is designed to enhance the properties and structure of the alumina, facilitating the formation of alpha-alumina support. Additionally, the aim is to ensure a uniform and effective alkali metal oxide coating, optimizing the support functionality for subsequent catalytic applications.

In one or more embodiments, once the second step has taken place, the third step may take place, comprising depositing a precursor outer shell layer onto the intermediate shell layer 120 such that the precursor outer shell layer surrounds the intermediate shell layer 120. The precursor outer shell layer may comprise, consist essentially of, or consist of the combination of one or more alkali metal-containing compounds and one or more nickel-containing compounds, and solvent. The precursor outer shell layer may comprise the alkali metal-containing compound and nickel-containing compound in a solvent. Without limitation, potassium-containing compounds may be chosen from potassium hydroxide, potassium carbonate, potassium nitrate, potassium bicarbonate, potassium acetate, potassium tert-butoxide, or potassium citrate, and the nickel-containing compounds may be chosen from nickel (II) chloride, acetate, carbonate, hydroxide, nitrite, or nitrate. The solvent may be water or a hydrocarbon solvent, and is not necessarily limited. The alkali metal-containing compound may be in a mixture with the solvent where the ratio of alkali metal-containing compound to solvent is from 0.1 wt. % to 5 wt. % of alkali metal-containing compound relative to the total weight of the mixture. Similarly, the nickel-containing compound and the nickel-containing compound may be in a mixture with the solvent where the ratio of nickel-containing compound to solvent is from 1 wt. % to 30 wt. % of alkali metal-containing compound relative to the total weight of the mixture. According to embodiments the mixture of alkali metal-containing compound, nickel-containing compound, and solvent may be agitated via stirring or shearing at speeds ranging from 100 to 1500 rpm and a temperature from 20 °C to 80 °C for from 1 to 12 hours. As described herein, the “depositing” of the precursor outer shell layer may be by a variety of techniques, and is not particularly limited. However, in some embodiments, the deposition may be by dipping, spraying, or other like techniques. Following the deposition, the core portion 110 and intermediate shell layer 120 with the deposited precursor outer shell layer may be rested at ambient temperature and/or dried at from 80 °C to 120 °C from 18 to 48 hours under atmospheric pressure to remove solvent, preparing it for the subsequent fourth step.

In one or more embodiments, once the third step has taken place, the fourth step may take place, comprising calcining the precursor outer shell layer to form an outer shell layer comprising alkali metal oxide and nickel oxide. This calcining procedure may drive off any residual solvent and may convert the alkali metal-containing compound and nickel-containing compound into alkali metal oxide and nickel oxide. The calcining process may comprise heating the catalyst from room temperature to 700 °C or greater at a rate of 1 to 20 °C/min, followed by an isothermal hold for 4 to 8 hours. Without being bound by theory, this calcination process is designed to enhance the properties and structure of the alumina, facilitating the formation of alpha-alumina support. Additionally, the aim is to achieve a homogeneous and effective alkali metal with nickel oxide coating, thereby optimizing the support functionality for its intended catalytic applications.

Now described are methods for utilizing the disclosed catalysts for catalytic cracking of ammonia to form hydrogen. As described herein, “hydrogen” refers to H₂ or hydrogen gas. According to embodiments, the method may comprise contacting ammonia with the catalyst to form H₂. In one or more embodiments, the temperature of reaction may be relatively low as compared to some conventional ammonia cracking processes, such as from 425 °C to 750 °C. For example, the temperature of reaction may be less than or equal to 450 °C, less than or equal to 475 °C, less than or equal to 500 °C, less than or equal to 525 °C, less than or equal to 550 °C, less than or equal to 575 °C, less than or equal to 600 °C, less than or equal to 625 °C, less than or equal to 650 °C, less than or equal to 675 °C, less than or equal to 700 °C, or less than or equal to 450 °C.

The presently disclosed methods may be superior to or at least equal in value to other methods for converting ammonia into hydrogen. These other methods may include thermal decomposition where ammonia is thermally decomposed into nitrogen and hydrogen at high temperatures, typically without the presence of a catalyst; steam reforming of ammonia over a catalyst to produce hydrogen and nitrogen; electrochemical decomposition were ammonia is decomposed into hydrogen and nitrogen using an electrochemical cell; plasma decomposition where ammonia is decomposed using plasma technology, where high-energy plasma provides the energy needed for the decomposition reaction; and photo-catalytic decomposition where applied Vis/UV light is aimed to decompose ammonia into hydrogen and nitrogen in the presence of a suitable photocatalyst.

In some embodiments, the catalysts described herein may not include ruthenium, which is a relatively high-cost material for incorporation into a catalyst. Additional embodiments may not include cobalt.

Numerous technical aspects are disclosed herein, which are described below as Aspects 1-15. Aspect 1. A catalyst comprising: a core portion comprising alpha-alumina; an intermediate shell layer surrounding the core portion, the intermediate shell layer comprising an alkali metal oxide; an outer shell layer surrounding the intermediate shell layer, the outer shell portion comprising an alkali metal oxide and nickel oxide, wherein the alkali metal oxide of the outer shell layer and the nickel oxide are mixed in the outer shell layer.

Aspect 2. The catalyst of any previous Aspect, wherein the alkali metal oxide in the intermediate shell layer is potassium oxide, and wherein the alkali metal oxide in the outer shell layer is potassium oxide.

Aspect 3. The catalyst of any previous Aspect, wherein the core layer consists essentially of alpha-alumina.

Aspect 4. The catalyst of any previous Aspect, wherein the intermediate shell layer consists essentially of the alkali metal oxide, and wherein the outer shell layer consists essentially of the alkali metal oxide and nickel oxide.

Aspect 5. The catalyst of any previous Aspect, wherein the weight ratio of alkali metal oxide to nickel oxide in the outer shell layer is from 1:25 to 1:1.

Aspect 6. The catalyst of any previous Aspect, wherein the core portion is in direct contact with the intermediate shell layer, and the intermediate shell layer is in direct contact with the outer shell layer.

Aspect 7. The catalyst of any previous Aspect, wherein the alkali metal oxide of the intermediate shell layer is potassium oxide, and wherein the intermediate shell layer further comprises another alkali metal oxide.

Aspect 8. The catalyst of any previous Aspect, wherein the alkali metal oxide of the outer shell layer is potassium oxide, and wherein the outer shell layer further comprises another alkali metal oxide.

Aspect 9. A method for catalytically cracking ammonia, the method comprising contacting ammonia with the catalyst of any previous Aspect to form H₂.

Aspect 10. The method of any previous Aspect, wherein the contacting is performed at a temperature of from 425 °C to 750 °C.

Aspect 11. A method for making a catalyst, the method comprising: depositing a precursor intermediate shell layer onto a core portion such that the precursor intermediate shell layer surrounds the core portion, wherein the core portion comprises alpha-alumina, and wherein the precursor intermediate shell layer comprises an alkali metal-containing compound; calcining the precursor intermediate shell layer to form an intermediate shell layer comprising alkali metal oxide; depositing a precursor outer shell layer onto the intermediate shell layer such that the precursor outer shell layer surrounds the intermediate shell layer, wherein the precursor outer shell layer comprises a mixture comprising an alkali metal-containing compound and a nickel-containing compound; and calcining the precursor outer shell layer to form an outer shell layer comprising alkali metal oxide and nickel oxide.

Aspect 12. The method of any previous Aspect, further comprising forming the core portion by a method comprising calcining non-alpha-alumina, one or more aluminum-containing compounds, or combinations thereof.

Aspect 13. The method of any previous Aspect, wherein the precursor intermediate shell layer comprises the metal oxide-containing compound in a solvent, and wherein the precursor outer shell layer comprises the metal oxide-containing compound and the nickel-containing compound in a solvent.

Aspect 14. The method of any previous Aspect, wherein the catalyst is the catalyst of any previous Aspect.

Aspect 15. The method of any previous Aspect, wherein: the alkali metal-containing compound is chosen from potassium hydroxide, potassium carbonate, potassium nitrate, potassium bicarbonate, potassium acetate, potassium tert-butoxide, or potassium citrate; and the nickel-containing compound is chosen from nickel (II) chloride, nickel (II) acetate, nickel (II) carbonate, nickel (II) hydroxide, nickel (II) nitrite, or nickel (II) nitrate.

### EXAMPLES

The various embodiments of the methods of the present disclosure will be further clarified by the following examples. The examples are illustrative in nature, and should not be understood to limit the subject matter of the present disclosure.

### Example 1—Catalyst Fabrication and Characterization

Catalyst Sample A was prepared according to the disclosures herein utilizing an alpha-alumina core portion formed by calcining at 1100 °C. More specifically, intermediate shell layer was formed of potassium oxide (5 wt. % potassium in solvent), and the outer shell layer was formed of mixed potassium oxide and nickel oxide and had a mass ratio of 1:7.5 of potassium oxide:nickel oxide metal in the outer shell layer (15 wt. % equivalent nickel precursor and 2 wt. % equivalent potassium precursor in solvent). Comparative Catalyst Sample Z was prepared identically to Catalyst Sample A, but utilized a gamma-alumina core portion formed by calcining at only 700 °C.

The textural properties of both catalysts were examined using nitrogen adsorption techniques, as detailed in Table 1. The findings highlight a reduction in surface area, but an increased in pore volume and pore size, particularly in the catalyst supported by alpha-alumina.

TABLE 1
Textural properties using nitrogen adsorption of catalysts

| | BET Surface Area, | Pore Volume, | Pore Size, |
|---|---|---|---|
| | m²/g | cm³/g | nm |
| Sample A | 67.5 | 0.08 | 4.9 |
| Comparative Sample Z | 49.9 | 0.14 | 11.9 |

### Example 2—Ammonia Cracking Catalytic Activity

Example 2 investigates the performance of the two catalysts produced in Example 1, as well as two additional conventional catalysts disclosed in the literature, referred to herein as Comparative Sample Y and Comparative Sample X. Comparative Sample Y is from Cerrillo, Jose L., et al. “High purity, self-sustained, pressurized hydrogen production from ammonia in a catalytic membrane reactor,” Chemical Engineering Journal 431 (2022) 134310 (utilizing the 1 bar example). Comparative Sample Y is from Al-Shafei, Emad N., et al., “The effect of acidic-basic structural modification of nickel-based catalyst for ammonia decomposition for hydrogen generation,” Molecular Catalysis 550 (2023) 113581. In general, Comparative Y includes a BaCoCe composite catalyst, and Comparative Z includes a NiK/gamma-alumina catalyst.

In a fixed-bed catalytic cracking setup, 0.40 g of each catalyst was tested with a gas flow rate of 30 ml/min, using a mixture of 10 vol % ammonia and 90 vol % helium. The catalytic cracking experiments were conducted at four different temperatures: 400 °C, 450 °C, 485 °C, and 500 °C at 1 bar. The results are shown in Table 2. A superior ammonia conversion efficiency using Catalyst Sample A was observed compared to the Comparative Catalyst Sample Z, Y, and X at reaction temperatures above 400 °C, demonstrating the significant impact of support material and thermal treatment on the catalyst's effectiveness in ammonia cracking.

TABLE 2
Ammonia Conversion

| | Ammonia Conversion % at | | | |
|---|---|---|---|---|
| | given Reaction Temperature | | | |
| | 400 °C | 450 °C | 485 °C | 500 °C |
| Sample A | 17% | 51.5% | 76% | 84% |
| Comparative Sample Z | 24% | 33% | 64.5% | 72% |
| Comparative Sample Y | 12.5% | 30% | 53% | N/A |
| Comparative Sample X | 17% | 43% | 68% | 78% |

As descried herein the term “consisting essentially of” refers to a component comprising 99.5 wt. % or more of a substance, thereby including embodiments where trace amounts of other materials may be present in relatively small amounts.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and [symbol] interpreted in like manner as the more commonly used open-ended preamble term “comprising.”

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.” It is also noted that recitations herein of “at least one” component, element, etc., should not be used to create an inference that the alternative use of the articles “a” or “an” should be limited to a single component, element, etc. It is also noted that recitations herein of “at least” followed by a quantitative value should be understood as being equivalent to “greater than or equal to” the quantitative value.

1. A catalyst comprising:
a core portion comprising alpha-alumina;
an intermediate shell layer surrounding the core portion, the intermediate shell layer comprising an alkali metal oxide; and
an outer shell layer surrounding the intermediate shell layer, the outer shell portion comprising an alkali metal oxide and nickel oxide, wherein the alkali metal oxide of the outer shell layer and the nickel oxide are mixed in the outer shell layer.

2. The catalyst of claim 1, wherein the alkali metal oxide in the intermediate shell layer is potassium oxide, and wherein the alkali metal oxide in the outer shell layer is potassium oxide.

3. The catalyst of claim 1, wherein the core layer consists essentially of alpha-alumina.

4. The catalyst of claim 1, wherein the intermediate shell layer consists essentially of the alkali metal oxide, and wherein the outer shell layer consists essentially of the alkali metal oxide and nickel oxide.

5. The catalyst of claim 1, wherein the weight ratio of alkali metal oxide to nickel oxide in the outer shell layer is from 1:25 to 1:1.

6. The catalyst of claim 1, wherein the core portion is in direct contact with the intermediate shell layer, and the intermediate shell layer is in direct contact with the outer shell layer.

7. The catalyst of claim 1, wherein the alkali metal oxide of the intermediate shell layer is potassium oxide, and wherein the intermediate shell layer further comprises another alkali metal oxide.

8. The catalyst of claim 1, wherein the alkali metal oxide of the outer shell layer is potassium oxide, and wherein the outer shell layer further comprises another alkali metal oxide.

9. A method for catalytically cracking ammonia, the method comprising contacting ammonia with the catalyst of claim 1 to form H₂.

10. The method of claim 9, wherein the contacting is performed at a temperature of from 425 °C to 750 °C.

11. The catalyst of claim 1, wherein:
the core portion consists essentially of alpha-alumina; and
the intermediate shell layer consists essentially of the alkali metal oxide.

12. The catalyst of claim 11, wherein the alkali metal oxide in the intermediate shell layer is potassium oxide, and wherein the alkali metal oxide in the outer shell layer is potassium oxide.

13. The catalyst of claim 11, wherein the weight ratio of alkali metal oxide to nickel oxide in the outer shell layer is from 1:25 to 1:1.

14. The catalyst of claim 11, wherein the core portion is in direct contact with the intermediate shell layer, and the intermediate shell layer is in direct contact with the outer shell layer.

15. The catalyst of claim 1, wherein:
the core portion consists of the alpha-alumina; and
the intermediate shell layer consists of the alkali metal oxide.

16. A method for making a catalyst, the method comprising:
depositing a precursor intermediate shell layer onto a core portion such that the precursor intermediate shell layer surrounds the core portion, wherein the core portion comprises alpha-alumina, and wherein the precursor intermediate shell layer comprises an alkali metal-containing compound;
calcining the precursor intermediate shell layer to form an intermediate shell layer comprising alkali metal oxide;
depositing a precursor outer shell layer onto the intermediate shell layer such that the precursor outer shell layer surrounds the intermediate shell layer, wherein the precursor outer shell layer comprises a mixture comprising an alkali metal-containing compound and a nickel-containing compound; and
calcining the precursor outer shell layer to form an outer shell layer comprising alkali metal oxide and nickel oxide.

17. The method of claim 16, further comprising forming the core portion by a method comprising calcining non-alpha-alumina, one or more aluminum-containing compounds, or combinations thereof.

18. The method of claim 16, wherein the precursor intermediate shell layer comprises the metal oxide-containing compound in a solvent, and wherein the precursor outer shell layer comprises the metal oxide-containing compound and the nickel-containing compound in a solvent.

19. The method of claim 16, wherein the catalyst is the catalyst of claim 1.

20. The method of claim 16, wherein:
the alkali metal-containing compound is chosen from potassium hydroxide, potassium carbonate, potassium nitrate, potassium bicarbonate, potassium acetate, potassium tert-butoxide, or potassium citrate; and
the nickel-containing compound is chosen from nickel (II) chloride, nickel (II) acetate, nickel (II) carbonate, nickel (II) hydroxide, nickel (II) nitrite, or nickel (II) nitrate.
